(19) United States
(12) Patent Application Publication
(10) Pub. No.: US 2018/0040091 A1
(43) Pub. Date: Feb. 8, 2018

(54) METHOD AND SYSTEM FOR ELECTRONIC IDENTITY & LICENSURE VERIFICATION

(71) Applicant: COLLATERAL OPPORTUNITIES, LLC, Wilmington, DE (US)

(72) Inventor: MICHAEL KUSENS, COOPER CITY, FL (US)

(21) Appl. No.: 15/667,597

(22) Filed: Aug. 2, 2017

Related U.S. Application Data
(60) Provisional application No. 62/370,324, filed on Aug. 3, 2016.

(51) Int. Cl. G06Q 50/26; G06Q 10/10

(52) U.S. Cl. CPC G06Q 50/265; G06Q 10/10; H04W 4/02

(57) ABSTRACT

A system and method for verifying the identity of a first individual by a second individual who is preferably within range, such as, but not limited to, viewing range of the first individual. The first individual receives an Identification Token on his or her electronic device from an Electronic Identification Verification System. When the first individual is within the vicinity of the second individual the Identification Token or a signal representative of the Identification Token is sent from the first individual's electronic device to the electronic device of the second individual. The second individual's electronic device sends the Identification Token to the Electronic Identification Verification System who obtains the verification information associated with the specific Identification Token from an Electronic Identification Verification Database. The verification information is then forwarded to the second individual's electronic device from the Electronic Identification Verification System for use by the second individual to confirm the identity of the first individual or determine that the first individual may be an imposter.

This application claims the benefit of and priority to U.S. Provisional Patent Application Ser. No. 62/370,324, filed Aug. 3, 2016, which is incorporated by reference in its entirety for all purposes.

### 1. FIELD OF THE DISCLOSURE

The disclosure relates generally identification systems and particular to a novel identification system for verifying the identity of a person without relying on line-of-sight vision.

### 2. BACKGROUND

A quick Internet search of the term “imposters knocking on door” reveals a multitude of stories of imposters knocking on the door of a residence claiming to be someone that they are clearly not. This includes representations about being a police officer, representative of a particular faith, delivery person, sales person, utility worker and more. In situations where there is an unsolicited approach of an individual claiming a particular identify, there is currently not much that can be done to verify the identity of this unknown individual without possibly exposing oneself to a high degree of risk. In a situation where someone unknown knocks on the front door of your residence, it would be safest to allow for identity verification to occur in a manner without having to open the door and thus exposing someone to unnecessary risk.

Other situations may present where it would be beneficial to verify the identity of an individual where the one seeking to do the verification is the person approaching or initiating the contact with the individual needing to be verified. Examples include, without limitation, an individual walking into a doctor's office for the first time or a client going to the office of a lawyer, accountant, or other licensed professional. Numerous cases exist where the person claiming to be a licensed professional is not truly licensed, not licensed to provide particular services, or has had a license suspended or revoked. Current identification verification systems are often limited to a physical identification (ID Badge, Government-Issued ID, Uniform, etc.) and typically require coming into close contact with the verification method to be able to utilize it. Many of these physical identification items can also be copied or forged in order to create a false identity. It is to simplify and help secure the process of identity verification of individuals both in person, as well as wirelessly, without relying on line-of-sight vision or communication that the current disclosure is directed.

SUMMARY OF THE DISCLOSURE A system and method are disclosed that allows for electronic identification of an individual. The ability to determine whether an individual has authorization to be in a restricted area is also considered part of this disclosure.

Non-limiting definitions that will be used in describing certain embodiments include:

| | |
|---|---|
| Beacon | A beacon comprises the components |
| | designed to send and receive |
| | electronic data used for monitoring |
| | an area for an Identification |
| | Token. A beacon may include any |
| | number of auditory, optical, radio |
| | and/or other sensor(s) and wireless |
| | transmitter(s)/receiver(s). The |
| | beacon(s) may be connected to the |
| | Electronic Identification |
| | Verification System through a wired |
| | and/or wireless network or |
| | another long or short-range |
| | frequency transmitter, or any other |
| | preferably wireless transmission |
| | technology now known or later |
| | developed. |
| Biometric | Any means by which a person can be |
| Information | uniquely identified by |
| | evaluating that person(s) distinguishing |
| | biological traits. For a non- |
| | limiting example, Biometric Information |
| | can include a person's voice, |
| | a member's iris scan, fingerprint(s), |
| | palm vein scan, facial scan, |
| | and/or other biometric information. |
| Data Storage | One or more electronic storage media, |
| | one or more electronic |
| | databases, random access memory |
| | (RAM), read-only memory (ROM), |
| | flash memory, and/or other types of |
| | electronic memory. |
| Electronic | A computer database that electronically |
| Identification | indexes information relating |
| Token | to Identification Token(s) and is in |
| Database | wired or wireless communication |
| | with a Member's Electronic Computer |
| | System/Device and/or the |
| | Electronic Identification Verification System. |
| Electronic | A computer database that electronically |
| Identification | indexes information relating |
| Verification | to electronic identification and is in |
| Database | wired or wireless communication |
| | with the Electronic Identification |
| | Verification System. Verification |
| | Information may include, without |
| | limitation, a Member's name, |
| | badge/identification number, photo, |
| | video, sound (for a non-limiting |
| | example the Member's voice), |
| | address/location, biometric information |
| | and/or other personal information. |
| Electronic | The Electronic Identification |
| Identification | Verification System can be a specially |
| Verification | programmed computer or electronic |
| System | system, which monitors and/or |
| | communicates with Member Electronic |
| | Computer System/Device(s), |
| | Beacon(s), and/or the Electronic System |
| | Administrator and maintains |
| | a database of Member(s) and |
| | Verification Information of Member(s). |
| | For non-limiting examples, |
| | Verification Information may include a |
| | Member's name, badge/identification |
| | number, photo, video, sound |
| | (such as, without limitation, the |
| | Member's voice), address/location, |
| | biometric information, licensure, |
| | allowable areas of practice, |
| | allowable locations of practice, and/or |
| | other personal or professional |
| | information. |
| Electronic | The person(s) responsible for the |
| System | administration of the identification |
| Administrator | verification system including entering |
| | and maintaining all identity |
| | information including, but not |
| | limited to, Member's name, |
| | badge/identification number, photo, |
| | video, sound (Member's voice, |
| | etc.), address/location, biometric |
| | information, licensure, allowable |
| | areas of practice, allowable locations |
| | of practice, and/or other personal |
| | or professional information. |
| Identification | An Identification Token contains a |
| Token | unique identifier that can be wired |
| | or preferably wireles sly transmitted |
| | from the Member's Electronic |
| | Computer System/Device (which |
| | can be, without limitation, a |
| | computer, tablet, cellphone, smart |
| | phone stand-alone beacon, etc.). In |
| | addition to or in the alternative, |
| | the Identification Token can be a |
| | unique UUID, Major and Minor |
| | value, MAC Address, IP Address, |
| | Serial Number, wired/wireless protocols |
| | (e.g. Ethernet, WiFi, RFID, |
| | Ultrasound, IR, etc.) token transmitted |
| | by Bluetooth or another long or |
| | short range frequency transmission |
| | technology or by other preferably |
| | wired or wireless transmission |
| | technology now known or later |
| | developed. |
| Member | Any person whose identity is verified |
| | by the Electronic Identification |
| | Verification System. |
| Member | Any electronic device which can |
| Electronic | utilize or communicate with one or |
| Computer | more of the following: the Internet, |
| System/Device | a wide area network (WAN), a |
| | local area network (LAN), a wireless |
| | local area network (WLAN), |
| | intranet, a metropolitan area network |
| | (MAN), a Bluetooth network |
| | and/or signal, a cellular network, |
| | such as 4G, 3G, GSM, etc., another |
| | wireless network, a gateway, and/or |
| | any other appropriate architecture |
| | or system that facilitates the |
| | communication of signals, data, and/or |
| | messages in order to send and |
| | receive data and/or voice |
| | communications. As non-limiting |
| | examples, cellular telephones, |
| | Bluetooth beacons, radio frequency |
| | badges and other types of wireless |
| | transmitters are considered to |
| | fall under this definition. |
| Transmission | The broadcasting of electromagnetic |
| | waves, signals, radio waves, |
| | electrical signals, light signals, |
| | Bluetooth signals, and/or other long or |
| | short-range frequencies transmission |
| | techniques now known or later |
| | developed. |
| End User/ | Any electronic device which can utilize |
| Customer | or communicate with one or |
| Electronic | Computer more of the following: the |
| System/Device | Internet, a wide area network (WAN), a |
| | local area network (LAN), a wireless |
| | local area network (WLAN), |
| | intranet, a metropolitan area network |
| | (MAN), a Bluetooth network |
| | and/or signal, a cellular network, |
| | such as 4G, 3G, GSM, etc., another |
| | wireless network, a gateway, and/or |
| | any other appropriate architecture |
| | or system that facilitates the |
| | communication of signals, data, and/or |
| | messages in order to send and |
| | receive data and/or voice |
| | communications now known or |
| | later developed. As non-limiting |
| | examples, cellular telephones, Bluetooth |
| | beacons, radio frequency |
| | badges and other types of wireless |
| | transmitters are considered to fall |
| | under this definition. |
| Electronic | A software application installed on |
| Identification | the End User/Customer's |
| Verification | Electronic Computer System/Device |
| System | that is programmed to monitor |
| Application | for known Identification Tokens |
| (App) | being transmitted by a Member's |
| | Electronic Computer System or |
| | Device. It is in communication with |
| | The Electronic Identification Verification |
| | System and Electronic |
| | Identification Verification System |
| | Database to compare the |
| | identification token received with |
| | the member's profile associated |
| | with the received token. |
| Verification | Information which can be used to |
| Information | determine the identity of a Member. |
| | Verification Information may include |
| | registration information, can |
| | include a Member's name, |
| | badge/identification number, photo, video, |
| | sound (e.g. the Member's voice, etc.), |
| | address/location, biometric |
| | information, an iris scan, fingerprint(s), |
| | palm vein scan, facial scan, or |
| | other biometric information. |

### BRIEF DESCRIPTION OF THE DRAWINGS

FIG. 1 is a block diagram and work flow for registration of members preferably initiated by a member in accordance with the disclosed system and method;

FIG. 2 is a block diagram and work flow for registration of members preferably initiated by a system administrator in accordance with the disclosed system and method;

FIG. 3 is a block diagram and work flow for verifying a member's identity preferably using one or more beacons and the electronic identification verification system in accordance with the disclosed system and method;

FIG. 4 is a block diagram and work flow for verifying a member's identity preferably using one or more beacons and the electronic identification verification system with location information in accordance with the disclosed system and method; and

FIG. 5 is a block diagram and work flow illustrating optional, though not limiting, biometric identifiers that can be used to determine or verify a member's identity in accordance with the disclosed system and method.

### DETAILED DESCRIPTION

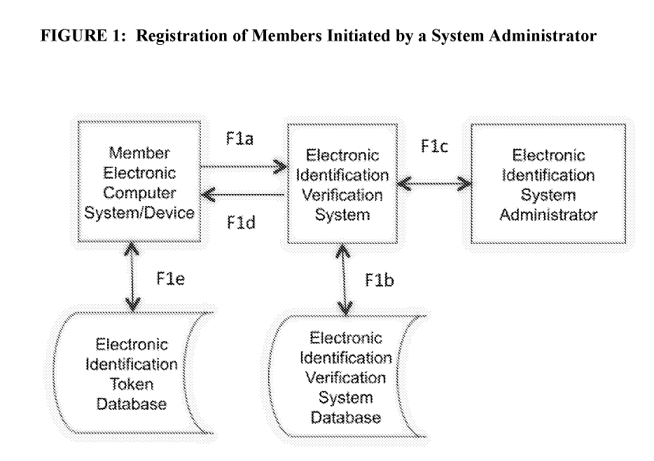

FIG. 1 shows the workflow for the registration of Members as preferably initiated by a Member.

At F1a, a Member can initiate the registration process by providing, inputting and/or uploading Verification Information to the Electronic Identification Verification System. As a non-limiting example, Verification Information can include a Member's name, badge/identification number, license number, photo, video, sound (e.g. Member's voice, etc.), address/location, biometric information, licensure, allowable areas of practice, allowable locations of practice, and/or other personal or professional information. The Electronic Identification Verification System can be a specially programmed computer or electronic system, which monitors and/or communicates with Member Electronic Computer System/Device(s), Beacon(s) and/or the Electronic System Administrator and maintains and communicates with a database of Member(s) and Verification Information of Member(s). The Verification Information can be provided to the Administrator, another authorized user of the System and/or a person who has access credentials to actually create a member profile on the system and also verify their identity. As a non-limiting example, for a company, the person(s) could be one or more individuals in the HR department at the Company that has (have) already done the verification of the employee's identity. It can also be someone akin to a notary that is allowed to verify someone's identity on behalf of a company or organization. As a non-limiting example, the member could provide verification information such as a government issued ID and/or any permits, licenses, or other credentials for the person. The verification information can be handed over in hard-copy form, uploaded from a disk and/or sent via electronic transmission (email/FTP/Website, etc.) and all are considered within the scope of the disclosure. Thus, it is preferred, however not required, to have at least one person responsible for activating members' profiles in the system only after positive confirmation of identity and credentials has been made.

At F1b, an electronic record of any Verification Information can be stored in an electronic database.

At F1c, the System Administrator can approve the registration of a Member. The System Administrator can be a person who collects and/or verifies a Member's name, badge/identification number, photo, video, sound (e.g. Member's voice, etc.), address/location, biometric information, licensure, allowable areas of practice, allowable locations of practice, and/or other personal or professional information. The System Administrator can authenticate and/or approve the Member's identification by performing any method of identification verification known (which can include, without limitation, comparing the Member to his/her government issued photo identification, biometric verification, and/or other identification method). The System Administrator can also upload additional Verification Information to the Electronic Identification Verification System where it is stored in an electronic database. Though not limiting, in many instances the Administrator can personally see the member and verify the information in front of the member. Though not limiting, the administrator can be associated with the company, agency, organization, etc. that is registering its members and confirming the identifications for the members. In another non-limiting scenario, the administrator at the company may review his or her own internal files for purposes of verification and issue the identification tokens without seeing the member in person. Thus, this verification can be a manual process, though it may be automated, especially, though not limiting, where the verification of identity has been done previously by the administrator with regards to the specific member.

At F1d, when a Member's identity is verified and the Member's profile approved by the System Administrator, that member can be assigned an Identification Token. That Identification Token preferably contains a unique identifier that can be wired or preferably wirelessly transmitted from the Electronic Identification Verification System to the Member's Electronic Computer System/Device (e.g. a computer, tablet, phone, stand-alone beacon, etc.). In addition to or in the alternative, the Identification Token can be a unique UUID, Major and Minor value, MAC Address, IP Address, Serial Number, wired/wireless protocols (e.g. Ethernet, WiFi, RFID, Ultrasound, IR, etc.) token transmitted by Bluetooth or another long or short-range frequency transmission technology or by other preferably wired or wireless transmission technology now known or later developed. The specific Member's Electronic Computer System/Device can store that Identification Token locally or remotely for future use with the Electronic Identification Verification System. The Identification Token for the specific Member can be preferably stored in an internal database on the Member's Electronic Computer System/Device and/or stored in memory of a physical dedicated beacon as well.

At F1e, an electronic record of any Identification Token(s) and the Member(s) associated with those Identification Token(s) can be stored in an electronic database for used or retrieval by the Electronic Identification Verifications System.

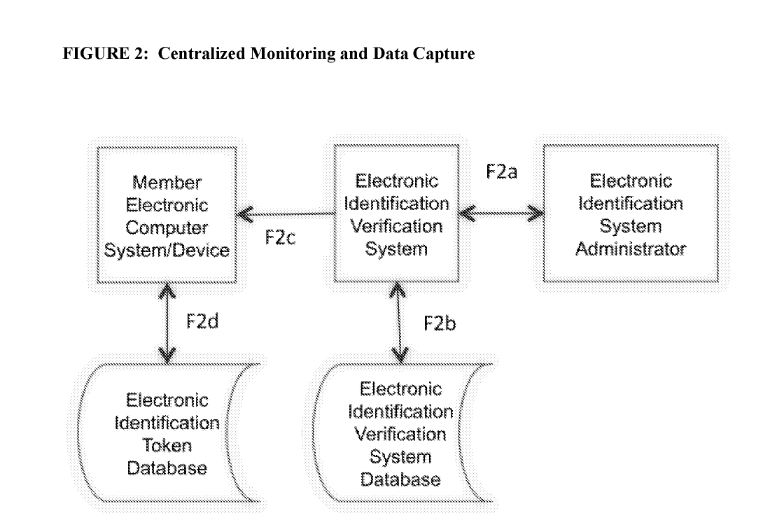

FIG. 2 shows the workflow for the registration of Members as initiated by a System Administrator.

At F2a, the System Administrator can initiate the registration of a Member. As one non-limiting example where the System Administrator may initiate registration, includes a group of members needing to be registered already in the System with their identifications already having been verified. Though not limiting, this could be a HR Administrator at a company registering all or a plurality of known employees for the company.

The System Administrator can be a person who collects and/or verifies a Member's name, badge/identification number, photo, video, sound (e.g. the Member's voice, etc.), address/location, biometric information, licensure, allowable areas of practice, allowable locations of practice, and/or other personal or professional information. The System Administrator can authenticate and/or approve the Member's identification by performing any method of identification verification known (e.g. comparing the Member to his/her government issued photo identification, biometric verification, and/or other identification method). The System Administrator can upload or input the Verification Information to the Electronic Identification Verification System where it is stored in an electronic database., such as the Electronic Identification Verification System Database.

At F2b, the Electronic Identification Verification System can be a specially programmed computer or electronic system, which monitors and/or communicates with Member Electronic Computer System/Device(s), Beacon(s) and/or the Electronic System Administrator and maintains a database of Member(s) and Verification Information for the Member(s). As non-limiting examples, Verification Information can include a Member's name, badge/identification number, photo, video, sound (e.g. the Member's voice, etc.), address/location, biometric information, licensure, allowable areas of practice, allowable locations of practice, and/or other personal or professional information. An electronic record of any Verification Information can be stored in an electronic database, such as the Electronic Identification Verification System Database.

At F2c, when a Member is registered by the System Administrator, that member can be assigned an Identification Token as described in FIG. 1.

At F2d, the identification token provided by the System Administrator is stored on the Member's Electronic Computer System or Device preferably in the Electronic Token Database on the member's electronic device.

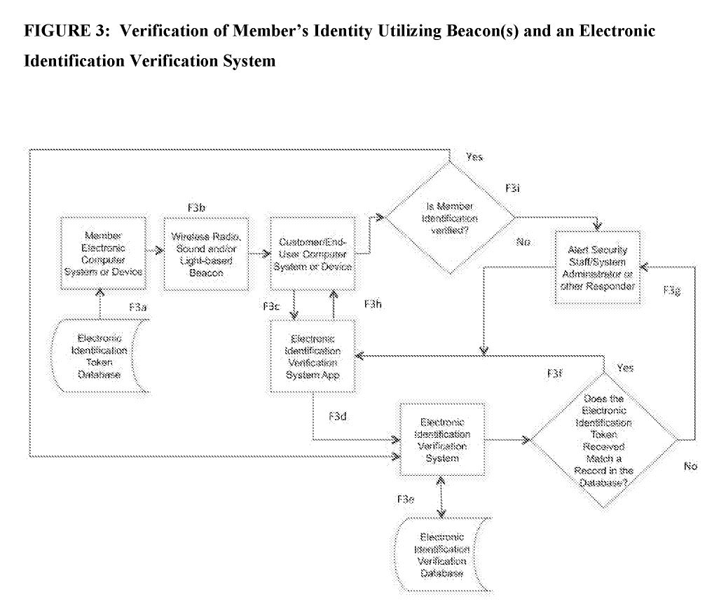

FIG. 3 shows verifying the identity of a member preferably using beacons and an electronic identification verification system.

At F3a, when a Member is registered by the System Administrator, that member can be assigned an Identification Token. That Identification Token contains a unique identifier that can be stored in an electronic token database on the Members device. The token can be continuously, intermittently, manually, or in any other fashion transmitted wired or preferably wirelessly from the Member's Electronic Computer System/Device (e.g. a computer, tablet, phone, stand-alone beacon, etc.) preferably to an electronic device of an end user/customer (e.g. a homeowner needing to verify delivery person's identity, etc.). As one non-limiting example, where a Member is using a cell phone and the end user is also using a cell phone, the beacon data can be transmitted from the Member to the end user. In addition to or in the alternative, the Identification Token can be a unique UUID, Major and Minor value, MAC Address, IP Address, Serial Number, wired/wireless protocols (for a non-limiting example Ethernet, WiFi, RFID, Ultrasound, IR, etc.) token transmitted by Bluetooth or another long or short-range frequency transmission technology or by other preferably wired or wireless transmission technology now known or later developed.

At F3b, the Member's Computer System or Device can continuously, intermittently, manually, or in any other fashion transmit the Identification Token to any potential end user seeking to verify the particular Member's identity. As a non-limiting example, a UPS/FedEx driver could have their phone constantly transmitting a beacon ID signal all day long. Anyone that comes in close proximity (within range of the transmission) and is running the Electronic Identification Verification System App on their electronic device could be able to determine the identity of the UPS/FedEx Driver. Most Bluetooth Low Energy beacons are configured to transmit between 1-10 times per second, 24 hours, 7 days a week, 365 days a year. A dedicated physical beacon can be used or the Member's phone allowed to have an app beacon that is constantly broadcasting. Alternatively, the app beacon or physical beacon can be turned on/off to only broadcast when the Member wants to broadcast/transmit. Thus, one non-limiting method to transmit the token is through the use of beacon(s), which may include any number of auditory, optical, radio and/or other sensor(s) and wireless transmitter(s)/receiver(s). The beacon(s) may be physically integrated into the Member's Electronic Computer System/Device or separate devices connected through a wired and/or wireless network or another long or short-range frequency transmitter, or any other preferably wireless transmission technology or protocol now known or later developed. When not integrated into the Member's Device, the beacon can be a badge or attached to a badge, a small keychain device, or even a sticker or in some other later developed form. Preferably, a company can market to or notify their customers (i.e. end users of the system) that they are implementing the disclosed novel wireless ID verification system and encourage the customers to download the App (which can be customized to be specifically associated with the company) on their cell phones/electronic device, in order for the customer to verify the identity of any delivery driver. The App on the customer's phone/electronic device can automatically notify the customer when it detects a known beacon in range by having the App constantly scan in the background for known beacon signals.

At F3c, an Electronic Identification Verification System Application can be installed on the Customer/End User's Computer System or Device. This application preferably utilizes the built-in wired and wireless network connections and radios (e.g. Ethernet, WiFi, RFID, Ultrasound, IR, etc.) of the Customer/End User's Computer System or Device to detect identification token signals broadcast from the beacons in F3b. The detection can be active (requiring user input of action) or passive (background scanning on the application at configured intervals) on the part of the user. Detections can either be automatic with the phone/electronic device app constantly scanning for Bluetooth beacon signals (token signals) and only acting when it detects a known token or they can be manual such as through a button on the screen for the app that can indicated “detect identity” or similar terminology (as a non-limiting example) and then scan for known beacons (tokens) for a short period of time if the button is pressed/selected.

At F3d, when an Identification Token is detected, that token is forwarded, rebroadcast, and/or otherwise transmitted to the Electronic Identification Verification System. The Customer/End User preferably performs the transmission through a preferred automatic process done by the App on the Customer/End User's phone/electronic device that initially detected the beacon signal.

At F3e, the Electronic Identification Verification System compares the Identification Token(s) which had been forwarded by the Customer/End User's Computer System or Device to a known database of Identification Token(s) which are stored in the Electronic Identification Token Database and assigned or associated with a Member. Preferably, there are only two databases used with the disclosed system, the central database of the system that holds the token information for all members and a small database on the member's cell phone/electronic device that stores the member's token. For a non-limiting example, a delivery company employee's phone can have the App installed with a token stored in the Apps database. That identification token can be broadcast once per second for the entire day (or some other selected or preconfigured broadcast interval) from the delivery driver's phone. A copy of that same token can be stored in the Central systems database along with the other profile information about the member. Through this comparison, the Electronic Identification Verification System automatically determines which Member's device has transmitted the token. As one non-limiting comparison example, the system can check if a particular Token ID exists in the Electronic Identification Verification System Database. As discussed below for F 3 f, all of the verification information can be sent to the Customer/End User's device. As a non-limiting example, for a delivery driver, the driver's picture, name, height, weight and/or eye color can be sent to the customer's phone/electronic device for the Token ID that was received. The Customer/End User can then manually use that information to make their own determination if the driver at the door is the person whose picture was just sent to them. Facial recognition software can also be used to compare the face of the person at the door to that of the stored pictured in the Electronic Identification Verification System database. Here, the customer/end user can take a picture with their electronic device having the app running on it and the facial recognition software preferably running on the customer's/end user's electronic device/phone can inform the customer/end user if the two pictures are of the same person of not.

At F3f, if the Electronic Identification Verification System determines that the Electronic Identification Token received matches a record in the Electronic Identification Token Database, which can be considered the main central database for the disclosed system that stores all Members' tokens and identification information, then the Electronic Identification Verification System preferably transmits all of the available Verification Information associated with the Member to the end user or the items of information previously selected or designated by the customer/end user, system administrator, etc.. Verification Information may include, without limitation, confirmation of the token validity, a Member's name, company, business or organization name, badge/identification number, photo, video, sound (e.g. the Member's voice, etc.), address/location, biometric information, licensure, allowable areas of practice, allowable locations of practice, and/or other personal or professional information. The process can then proceed to F3h.

At F3g, if the Electronic Identification Token does not match a record in the Electronic Identification Token Database, an alert can be given or transmitted to security, staff, administrator, police, law enforcement and/or other responder or designated individual via audible, visible or silent methods, notifying those individual(s) of a potential imposter. The alert can be sent by the computerized communication system which can include, but is not limited to, a system of speakers, microphones, lights, monitors, mobile phones and/or methods of communication including, but not limited to voice, email, SMS messaging, electronic alert transmission, API messaging, video, audio broadcast through one or more speakers within the room, phone calls and/or flashing lights. After notification, the Electronic Identification Verification System can resume monitoring as described in F 3 c. Notice/Alert can also be sent/transmitted to the customer's/end user's electronic device/cell phone.

At F3h, the Customer/End User utilizes the additional verification information provided to make a further determination as to the identity of the person transmitting the Electronic Identification Token. As a non-limiting example, the Customer/End User can compare the picture received for the Electronic Identification Token to the face of the person they are attempting to confirm the identity of.

At F3i, if the Customer/End User determines that the Member's identification is verified after a comparison of the member to the identity verification information received, the Customer/End User can initiate a confirmation signal to be sent to the Electronic Identification Verification System. As a non-limiting example, the Customer/End User can press an ID Verified button on their phone or ID Verified virtual button on their phone screen to initiate the confirmation message.

If the Customer/End User determines that the Members Identification is not verified after a comparison of the member to the identity verification information received, the Customer/Ed User can initiate an alert signal to the Electronic Identify Verification System as described in F3g.

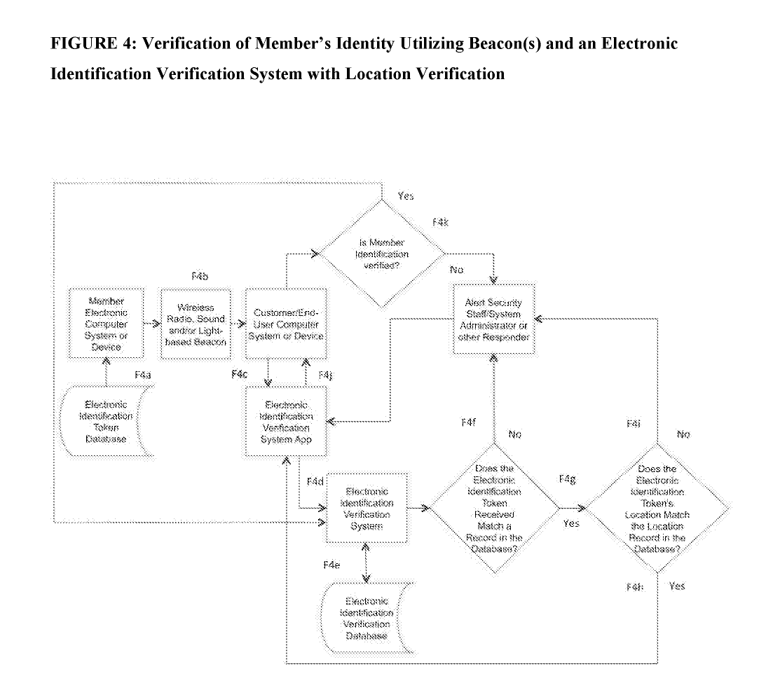

FIG. 4 illustrates a system and method for verification of a member's identity with location information.

At F4a, when a Member is registered by the System Administrator, that member can be assigned an Identification Token. That Identification Token contains a unique identifier that can be stored in an electronic token database on the Member's device. The token can be continuously, intermittently, manually, or in any other fashion transmitted wired or preferably wirelessly from the Member's Electronic Computer System/Device (e.g. a computer, tablet, phone, stand-alone beacon, etc.). In addition to or in the alternative, the Identification Token can be a unique UUID, Major and Minor value, MAC Address, IP Address, Serial Number, wired/wireless protocols (for a non-limiting example Ethernet, WiFi, RFID, Ultrasound, IR, etc.) token transmitted by Bluetooth or another long or short-range frequency transmission technology or by other preferably wired or wireless transmission technology now known or later developed,

At F4b, the Member's Computer System or Device can continuously, intermittently, manually, or in any other fashion transmit the Identification Token, which can be considered to be transmitted/broadcast freely from the Member's computer system/electronic device. The transmission/broadcast range can be controlled and in one non-limiting embodiment, the range can be from about 1 foot to about 300 feet. One method to transmit the token is through the use of beacon(s), which may include any number of auditory, optical, radio and/or other sensor(s) and wireless transmitter(s)/receiver(s). The beacon(s) may be physically integrated into the Member's Electronic Computer System/Device or separate devices connected through a wired and/or wireless network or another long or short-range frequency transmitter, or any other preferably wireless transmission technology or protocol now known or later developed. Preferably, the company/organization issuing the beacons (tokens) informs its customer base of the availability of the verification/identification system and encourages the customers/end users to download the App to their electronic devices. With the App downloaded, where a delivery driver for a company has an ID beacon, the information transmitted from the beacon can be received by the customer's App to verify the identity of the driver.

At F4c, an Electronic Identification Verification System Application can be installed on the Customer/End User's Computer System or Device. This application preferably utilizes the built in wired and wireless network connections and radios (e.g. Ethernet, WiFi, RFID, Ultras-und, IR, etc.) of the Customer/End User's Computer System or Device to detect identification token signals broadcast from the beacons in F3d. The detection can be active (requiring user input of action) or passive (background scanning on the application at configured intervals) on the part of the user.

At F4d, when an Identification Token is detected, that token is forwarded, rebroadcast, and/or otherwise transmitted to the Electronic Identification Verification System. Additionally, location information can be provided to the Electronic Information Verification System of where the token was acquired from, which in one non-limiting example can be obtained from the GPS on the customer/end user's electronic device. Thus, the location information can be generated by the Customer/End User's Computer System or Device. The location data is preferably provided by the customer/end user's electronic device. As a non-limiting example, GPS, IP Address, WiFi, Cellular Tower Triangulation or other location technology may be utilized by the Customer/End User's Computer System or Device to determine the current location of the customer/end user's phone/electronic device at the time the token is received. As a real world non-limiting example, a doctor can be a member and has the token issued by the licensing board for doctors. In the main, central database for the Electronic Identification Verification System, the doctor's office location may be stored. Where the ID Token beacon transmission is limited to a range of a few hundred feet or less, the GPS provided location of the customer/end user's electronic device at the time they receive the beacon signal from the ID Token can be used and compared to the stored assigned location for the particular ID Token.

At F4e, the Electronic Identification Verification System compares the Identification Token(s) which had been forwarded by the Customer/End User's Computer System or Device to a known database of Identification Token(s) which are stored in the Electronic Identification Token Database (the main, central database) and assigned or associated with a Member. Through this comparison, the Electronic Identification Verification System automatically determines which Member's device has transmitted the token and that it has been transmitted from the location assigned to the token or the location from where the token was acquired, preferably, though not limiting, where the location is important for the particular circumstances that the novel system is being used for. As a non-limiting example, many professionals require licensing and those licenses are often issued by a professional organization overseeing those professionals. The professional license may only allow the professional to practice from a particular location or within a specific geographic location (i.e. a particular State). The disclosed system can be used to issue a ID Token to the professional with a location attached to it containing the office location for the professional or other geographical restriction (i.e. within a state border, within a county border, etc.) When a customer/client or other individual comes to the professional's office for a meeting, they can receive the professional's ID Token on their phone/electronic device and then the ID Token can be compared against the central database maintained by the licensing organization. Where the meeting is at the registered location or within some other geographical restriction/limitation stored in the central database, no alert is needed. However, if the meeting is at a different location from the registered location (office or outside certain geographical border), upon performing the comparison the system will let the customer/end user know that the ID Token it received is only valid at the registered office location/within a certain geographical area and not the place of the meeting. Thus, another layer of protection/security can be provided to the end user. Additionally, even if the meeting is not at the registered location, other information in the ID Token, such as, but not limited to, a photo of the professional can also be used by the customer/end user to verify that the professional present at the location (whether the registered location or another location) is the professional they are supposed to be meeting with.

At F4f, if the Electronic Identification Token does not match a record in the Electronic Identification Token Database (i.e. the main, central database), an alert can be given or transmitted to security, staff, administrator, police, law enforcement and/or other responder or other designated individual via audible, visible or silent methods, notifying those individual(s) of a potential imposter. The alert can be sent by the computerized communication system which can include, but is not limited to, a system of speakers, microphones lights, monitors, mobile phones and/or methods of communication including but not limited to voice, email, SMS messaging, electronic alert transmission, API messaging, video, audio broadcast through one or more speakers within the room, phone calls and/or flashing lights. After notification the Electronic Identification Verification System can resume monitoring as described in F4c. Notice/Alert can also be sent/transmitted to the customer' s/end user's electronic device/cell phone.

If the Electronic Identification Verification System determines that the Electronic Identification Token received matches a record in the Electronic Identification Token Database (i.e. the main, central database), then the then the process continues to F4g.

At F4g, the Electronic Identification Verification System determines whether the token was received from and/or within a known and authorized location.

At F4h, if the Electronic Identification Verification System determines that the Location information received for Electronic Identification Token matches an authorized location record and/or is within an authorized geographical location stored in the Electronic Identification Token Database (i.e. the main, central database), then the Electronic Identification Verification System transmits all of the available Verification Information associated with the Member to the end user or the items of information previously selected or designated by the customer/end user, system administrator, etc. As non-limiting examples, Verification Information may include confirmation of the token validity, a Member's name, company, business or organization name, badge/identification number, photo, video, sound (e.g. the Member's voice, etc.), address/location, biometric information, licensure, allowable areas of practice, allowable locations of practice, and/or other personal or professional information.

At F4i, if the Location information received for the Electronic Identification Token does not match an authorized location record and/or is not within an authorized geographical location stored in the Electronic Identification Token Database, an alert can be given or transmitted to security, staff, administrator, law enforcement and/or other responder via audible, visible or silent methods, notifying those individual of a potential imposter. The alert can be sent by the computerized communication system which can include, but is not limited to, a system of speakers, microphones lights, monitors, mobile phones and/or methods of communication including, but not limited to, voice, email, SMS messaging, electronic alert transmission, API messaging, video, audio broadcast through one or more speakers within the room, phone calls and/or flashing lights. After notification, the Electronic Identification Verification System can resume monitoring as described in F4c. Notice/Alert can also be sent/transmitted to the customer's/end user's electronic device/cell phone.

At F4j, the Customer/End User utilizes the additional verification information provided to make a further determination as to the identity of the person transmitting the Electronic Identification Token. As a non-limiting example, the Customer/End User can compare the picture provided of the Electronic Identification Token holder to the face of the person they are attempting to confirm the identity of.

At F4k, if the Customer/End User determines that the Members identification is verified after a comparison of the member to the identity verification information received, the Customer/End User can initiate a confirmation signal to be sent to the Electronic Identification Verification System. As a non-limiting example, the Customer/End User can press an ID Verified button on their phone or a ID Verified virtual button on their phone screen to initiate the confirmation message.

If the Customer/End User determines that the Members Identification is not verified after a comparison of the member to the identity verification information received, the Customer/Ed User can initiate an alert signal to the Electronic Identify Verification System as described in F3g.

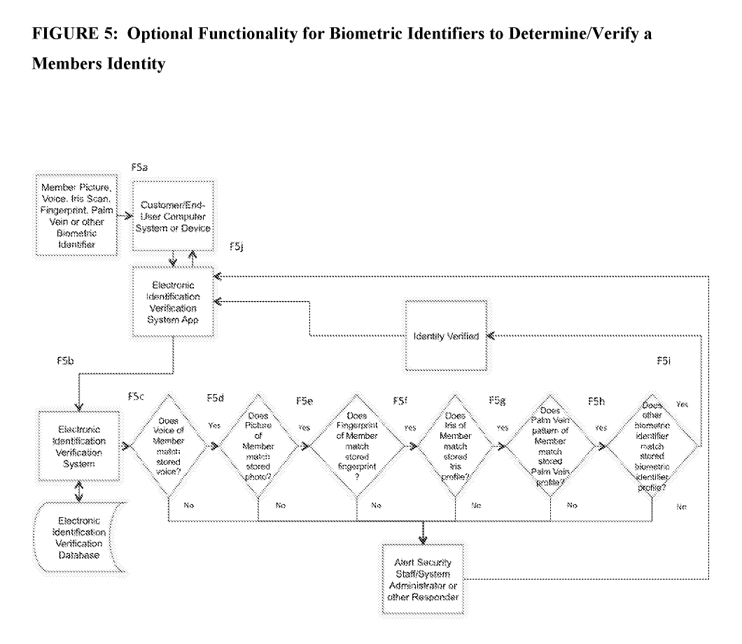

FIG. 5 illustrates the optional functionality for the preferred, though not limiting, biometric identifiers use to determine/verify a Member's identify.

At F5a, an Electronic Identification Verification System Application can be installed on the Customer/End User's Computer System or Device. This application can be configured to utilize internal algorithms and/or a device's internal or external camera, sensor, fingerprint reader, palm vein scanner, microphone, and/or other inputs to manually or automatically collect a Member's biometric and/or verification information (for a non-limiting example, samples of a Member's voice, a member's iris scan, fingerprint(s), palm vein scan, facial scan, or other biometric information). This biometric identification is in addition to the Electronic Identification Token received from the Member's Computer System or Device. The Application can be configured to manually or automatically begin the identification verification process, preferably after obtaining the additional biometric/verification information from the Member. Certain of these additional verification methods may require close contact, whereas some such as taking a picture of the Member (i.e. through a window or peep hole) can be done at a distance. Voice print analysis may be performed without close physical contact and rather through windows and/or doors. For uses, where the customer goes to the Member's location (i.e. patient-customer going to a doctor-member's office, etc.) the customer is already in close contact and here biometrics may be a preferred verification choice.

At F5b, the Electronic Identification Verification System can be a specially programmed computer or electronic system, which monitors and/or communicates with Member Electronic Computer System/Device(s) and/or the Electronic System Administrator and maintains a database of Member(s) and Verification Information of Member(s). As non-limiting example, Verification Information may include registration information can include a Member's name, company, business or organization name, badge/identification number, photo, video, sound (e.g. example the Member's voice, etc.), address/location, biometric information, an iris scan, fingerprint(s), palm vein scan, facial scan, or other biometric information). An electronic record of any Verification Information can be stored in an electronic database, such as the main central Electronic Identification Verification System database.

At F5c, the Electronic Identification Verification System Application can be configured to manually or automatically record, collect, and/or detect a Member's voice (preferably by using a microphone on the customer/end user's cell phone/electronic device), and compare that sound to a known sample of the Member's voice stored in the Electronic Identification Verification Database. If the Member's voice does not match the known sample of the Member's voice stored in the Electronic Identification Verification Database, then an alert can be issued as described in FIG. F5j.

At F5d, the Electronic Identification Verification System Application can be configured to manually or automatically photograph a Member or otherwise record, collect and/or store a Member's image (such as, but not limited to, through a window or peep hole), and compare that image to a known image of the Member stored in the Electronic Identification Verification Database. If the Member's image does not match the known image of the Member's stored in the Electronic Identification Verification Database, then an alert can be issued as described in FIG. F5j.

At F5e, the Electronic Identification Verification System Application can be configured to manually or automatically record, collect, and/or detect a Member's fingerprint (i.e. collecting biometrics from the Member on the customer/end user's electronic device/cell phone, etc.), and compare that scan (captured fingerprint) to a known copy of the Member's fingerprint stored in the Electronic Identification Verification Database. If the Member's fingerprint does not match the known copy of the Member's fingerprint stored in the Electronic Identification Verification Database, then an alert can be issued as described in FIG. F5j.

At F5f, the Electronic Identification Verification System Application can be configured to manually or automatically record, collect, and/or detect a Member's iris scan (i.e. collecting biometrics from the Member on the customer/end user's electronic device/cell phone, etc.), and compare that scan to a known copy of the Member's iris scan stored in the Electronic Identification Verification Database. If the Member's iris scan does not match the known copy of the Member's iris scan stored in the Electronic Identification Verification Database, then an alert can be issued as described in FIG. F5j.

At F5g, the electronic Identification Verification System Application can be configured to manually or automatically record, collect, and/or detect a Member's palm vein pattern (i.e. collecting biometrics from the Member on the customer/end user's electronic device/cell phone, etc.), and compare that pattern to a known sample of the Member's palm vein pattern stored in the Electronic Identification Verification Database. If the Member's palm vein pattern does not match the known sample of the Member's palm vein pattern stored in the Electronic Identification Verification Database, then an alert can be issued as described in FIG. F5j.

At F5h, the Electronic Identification Verification System Application can be configured to manually or automatically record, collect, and/or detect any other biometric identification information (i.e. collecting biometrics from the Member on the customer/end user's electronic device/cell phone, etc.), and compare that biometric identification information to a known copy/sample of the Member's biometric identification information stored in the Electronic Identification Verification Database. If the Member's biometric identification information does not match the known copy/sample of the Member's biometric identification information stored in the Electronic Identification Verification Database, then an alert can be issued as described in FIG. F5j.

At F5i, if the Electronic Identification Verification System Application determines that the Member's identity has been verified based on a positive match in figures F5c through F5h (or one or more of the verifiers discussed in F5c through F5h), then the Member's identity can be considered verified, the Customer/End User can be notified via the App on their Computer System or Device and the application can resume monitoring. The System does not need to use all of the verifiers discussed in F5c through F5h, though it is within the scope of the disclosure that they all are used. Additionally, any one of the verifiers can be used as a single verification method or any combination of the verifiers can be used, preferably depending on the level of security desired and/or as the “use” situation/scenario needs.

At F5j, if the Electronic Identification Verification System Application determines that the Member's identity has not been verified based on a negative match in any of FIGS. F5c through F5h, (or one or more of the verifiers discussed in F5c through F5h), an alert can be given or transmitted to security, staff, administrator, and/or other responder via audible, visible or silent methods, notifying those individual of a potential imposter. The verifiers discussed in F 5 c through F 5 h can be used individually or in any number of combinations to verify the identity of a member. The alert can be sent by the computerized communication system which can include, but is not limited to, a system of speakers, microphones lights, monitors, mobile phones and/or methods of communication including but not limited to voice, email, SMS messaging, electronic alert transmission, API messaging, video, audio broadcast through one or more speakers within the room, phone calls and/or flashing lights.

Additionally, the Customer/End User can be notified via the App on their Computer System or Device that the Members identity cannot be verified.

The following non-limiting components can be preferably used for operation of the disclosed embodiments:
1. One or more Customer/End User Computer Systems/Devices with the Electronic Identity Verification System App installed and running and with the Customer/End User Computer Systems/Devices in electronic communication with the Electronic Identification Verification System;
2. One or more Member Electronic Computer System or Device(s) in electronic communication with the Electronic Identification Verification System and containing an Electronic Identification Token and preferably a Beacon capable of transmitting the Electronic Identification Token;
3. Electronic Identification Verification System preferably in electronic communication with a system administrator and/or a storage system.

The various components can be in electrical, wired and/or wireless communication with each other.

Utilizing the Electronic Identification Verification & Licensure System will provide benefits and/or advantages to for profit and non-profit organizations and the general public alike, including, but not limited to, the following:
1. Increase the ability of Customer/End Users to verify the identity of an individual
2. Reduce security costs by increasing automation of identification verification.
3. Reduce the risks posed by misrepresentation of one's identity.
4. Increase in the safety of identification of individuals by allowing identification to take place wirelessly.
5. Increase in ability for companies/organizations to identify its members.

It should be understood that the exemplary embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from their spirit and scope.

All components of the described system and their locations, electronic communication methods between the system components, electronic storage mechanisms, etc. discussed above or shown in the drawings, if any, are merely by way of example and are not considered limiting and other component(s) and their locations, electronic communication methods, electronic storage mechanisms, etc. can be chosen and used and all are considered within the scope of the disclosure.

The benefits, advantages, solutions to problems, and any element(s) that may cause any benefit, advantage, or solution to occur or become more pronounced are not to be construed or considered as a critical, required, or essential features or elements of any or all the claims.

Unless feature(s), part(s), component(s), characteristic(s) or function(s) described in the specification or shown in the drawings for a claim element, claim step or claim term specifically appear in the claim with the claim element, claim step or claim term, then the inventor does not consider such feature(s), part(s), component(s), characteristic(s) or function(s) to be included for the claim element, claim step or claim term in the claim when and if the claim element, claim step or claim term is interpreted or construed, whether during prosecution of this application or in litigation or similar proceeding. Similarly, with respect to any “means for” elements in the claims, the inventor considers such language to require only the minimal amount of features, components, steps, or parts from the specification to achieve the function of the “means for” language and not all of the features, components, steps or parts describe in the specification that are related or could be attributed to the function of the “means for” language.

While the disclosed embodiments have been described and disclosed in certain terms and has disclosed certain embodiments or modifications, persons skilled in the art who have acquainted themselves with the invention, will appreciate that it is not necessarily limited by such terms, nor to the specific embodiments and modification disclosed herein. Thus, a wide variety of alternatives, suggested by the teachings herein, can be practiced without departing from the spirit of the disclosure, and rights to such alternatives are particularly reserved and considered within the scope of the disclosure.

What is claimed is:

1. A method for verifying the identity of an individual, the method comprising the steps of:
a. receiving an Identification Token for a first individual whose identity needs to be verified by an electronic device possessed by a second individual, the Identification Token containing a unique identifier;
b. electronically transmitting the received Identification Token by the electronic device possessed by the second individual to a remotely located Electronic Identification Verification System; and
c. electronically receiving verification information for a person associated with the Identification Token by the electronic device of the second individual to allow the second individual to determine if the first individual and the person whose information is received in step c. are the same.

2. The method for verifying of claim 1 further comprising the step of transmitting the electronic Identification Token by an electronic device possessed by the first individual prior to step a.

3. The method for verifying of claim 2 further comprising the steps of receiving the electronic Identification Token by a wireless beacon contained within an electronic device of the first individual and electronically forwarding the electronic Identification Token to the electronic device of the second individual by the wireless beacon prior to step a.

4. The method for verifying of claim 1 wherein the electronic device of the second individual running an installed Electronic Identification Verification System Application.

5. The method for verifying of claim 1 wherein the first individual is a service provider and the second individual is an end user/customer for a company or business associated with the service provider.

6. The method for verifying of claim 1 further comprising the step of comparing the Identification Token by the Electronic Identification Verification System with known Identification Tokens stored in an Electronic Identification Token Database to identify the individual whose electronic device initially sent the Identification Token received by the electronic device of the second individual if a matching Identification Token is found in the Electronic Identification Token Database by the Electronic Identification Verification System.

7. The method for verifying of claim 1 wherein the verification information Is electronically transmitted by the Electronic Identification Verification System to the electronic device of the second individual when the Electronic Identification Verification System finds a matching Identification in an Electronic Identification Token Database that the Electronic Identification Verification System is in communication with.

8. A system for verifying the identity of a first individual by a second individual, said system comprising:
an Electronic Identification Verification System programmed to generate and forward Identification Tokens with a specific Identification Token assigned to the first individual;
an Electronic Identification Verification Database in communication with the Electronic Identification Verification System,
a first software app running on an electronic device possessed or used by the first individual, the first software app receiving the specific Identification Token sent by the Electronic Identification Verification System;
a second software app running on an electronic device possessed or used by the second individual, the second software app receiving the specific Identification Token sent by the electronic device of the first individual and forwarding the specific Identification Token to the Electronic Identification Verification System, wherein the Electronic Identification Verification System is programmed to obtain identifying/verification information for an individual assigned to the specific Identification Token which is stored in the Electronic Identification Verification Database and is programmed to forward the identifying verification information to the electronic device of the second individual for use by the second individual to verify the identity of the first individual.

9. The system for verifying of claim 8 wherein the identifying verification information is an image of the individual assigned to the specific Identification Token and the second individual compares the image to the first individual who is in a line of sight of the second individual.

10. The system for verifying of claim 9 wherein the identity of the first individual is verified by the second individual where a match is determined from comparing the first individual to the image of the individual assigned to the specific Identification Token.

11. The system for verifying of claim 9 further comprising a beacon for forwarding electronic information from the Electronic Identification Verification System and the electronic device of the first individual.

12. The system for verifying of claim 9 further comprising a beacon for forwarding electronic information from the electronic device of the first individual to the electronic device of the second individual.

13. The system for verifying of claim 9 further comprising a beacon for forwarding electronic information back and forth from the electronic device of the second individual and the Electronic Identification Verification System.

14. The system for verifying of claim 9 wherein the electronic device of the first individual is programmed through the first software app to continuously broadcast the specific Identification Token or a signal representative of the Identification Token.

15. The system for verifying of claim 14 wherein the Identification Token or a signal representative of the Identification Token is received by the electronic device of the second individual when a location of the electronic device of the first individual is close enough to a location of the electronic device of the second individual such that the electronic device of the second individual is within a broadcast range of the Identification Token or signal representative of the Identification Token broadcasted by the electronic device of the first individual.
